(19) United States
(12) Patent Application Publication
(10) Pub. No.: US 2025/0311029 A1
(43) Pub. Date: Oct. 2, 2025

(54) IDENTIFIER CONFIGURATION METHODS AND APPARATUSES, AND ELECTRONIC DEVICE AND STORAGE MEDIUM

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/863,564

(22) PCT Filed: May 6, 2022
(86) PCT No.: PCT/CN2022/091224

§ 371 Date: Nov. 6, 2024

(51) Int. Cl. H04W 76/14; H04W 84/18

(52) U.S. Cl. CPC H04W 76/14; H04W 84/18

(57) ABSTRACT

A method, apparatus and computer readable medium for configuring an identifier in a wireless communication system. The identifier is configured by: configuring a PIN element (PINE) identifier for a second PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

### CROSS REFERENCE TO RELATED APPLICATIONS

This application is a National Phase of International Application No. PCT/CN2022/091224, filed on May 6, 2022, the entire contents of which are incorporated herein by reference in their entirety.

### TECHNICAL FIELD

The present disclosure relates to the field of communication technologies and in particular, to identifier configuration methods and apparatuses, electronic devices, and storage mediums.

### BACKGROUND

Along with rapid development of Internet of Things (IoT), a Personal IoT Network (PIN) emerges. Specifically, the PIN is a smart service system which centers around individuals/individual users to connect human, things and other information resources by an electronic device based on agreed protocol so as to satisfy the requirements of individual users for high-quality and convenient lives. The PIN covers multiple scenarios such as household, travel, education, office and entertainment consumption and the like.

In the PINs, the electronic devices are usually referred to as PIN elements (PINE) and the PINEs are directly connected by PINs or networked for communication and managed locally by a PINE with management capability. The PIN elements are usually diversified, and in order to identify and manage them, identifiers for the PIN elements must be configured.

### SUMMARY

Embodiments of the present disclosure provide identifier configuration methods and apparatuses, electronic devices and storage mediums to provide a way to configure an identifier for a PIN element.

According to an aspect of the embodiments of the present disclosure, there is provided an identifier configuration method, performed by a first personal internet of things (IoT) network (PIN) device and including:
configuring a PIN element (PINE) identifier for a second PIN device;
where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

According to another aspect of the embodiments of the present disclosure, there is provided an identifier configuration method, performed by a second personal internet of things (IoT) network (PIN) device and including:
receiving a PIN element (PINE) identifier for the second PIN device configured by a first PIN device;
where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

The embodiments of the present disclosure provide an electronic device, including: a processor; and a memory storing computer programs executable by the processor, where the computer programs; when executed by the processor, cause the processor to perform the identifier configuration method in any one of the embodiments of the present disclosure.

The embodiments of the present disclosure provide a non-transitory computer-readable storage medium, storing computer programs thereon, where the computer programs, when executed by a processor, cause the processor to perform the identifier configuration method in any one of the embodiments of the present disclosure.

Additional aspects and advantages of the embodiments of the present disclosure will be partly given in the following descriptions and will become apparent from the following descriptions or be known by the practice of the present disclosure.

### BRIEF DESCRIPTION OF THE DRAWINGS

In order to more clearly describe the technical solutions of the present disclosure, the drawings required for descriptions of the embodiments of the present disclosure will be briefly introduced. Apparently, the drawings described hereunder are only some embodiments of the present disclosure. Those skilled in the arts can obtain other drawings based on these drawings without carrying out creative work.

FIG. 1 is a flowchart illustrating an identifier configuration method according to an embodiment of the present disclosure.

FIG. 2 is a flowchart illustrating an identifier configuration method according to another embodiment of the present disclosure.

FIG. 3 is a schematic diagram illustrating a first example according to an embodiment of the present disclosure.

FIG. 4 is a flowchart illustrating an identifier configuration method according to yet another embodiment of the present disclosure.

FIG. 5 is a schematic diagram illustrating a second example according to an embodiment of the present disclosure.

FIG. 6 is a flowchart illustrating an identifier configuration method according to still another embodiment of the present disclosure.

FIG. 7 is a structural schematic diagram illustrating an electronic device according to an embodiment of the present disclosure.

FIG. 8 is a structural schematic diagram illustrating an electronic device according to another embodiment of the present disclosure.

FIG. 9 is a structural schematic diagram illustrating an electronic device according to yet another embodiment of the present disclosure.

### DETAILED DESCRIPTION OF THE EMBODIMENTS

The wording “and/or” in the present disclosure describes an association relationship of an associated object, and indicates that three relationships may exist, e.g., A and/or B, which may be expressed as: A alone, both A and B, and B alone. The character “/” generally indicates an “or” relationship between the related objects.

The wording “plurality” in the present disclosure means two or more, and other quantifiers are similar.

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terminology used herein is for the purpose of describing particular embodiments only and is not intended to be limiting of the present disclosure. As used herein, the singular forms “a,” “said,” and “the” are intended to include the plural forms as well, unless the context clearly indicates otherwise. It will also be understood that as used herein, the term “and/or” is and includes any or all combinations of one or more of the items listed in the associated list.

It will be understood that while terms such as “first,” “second,” “third,” etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to a determination”.

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

Embodiments of the present disclosure provide identifier configuration methods and apparatuses, electronic devices and storage mediums to provide a way to configure an identifier for a PIN element.

The method and the apparatus are based on the same conception, and since the method and the apparatus solve problems on similar principles, the implementations of the apparatus and the method can be referred to each other, and the repetitions will not be repeated.

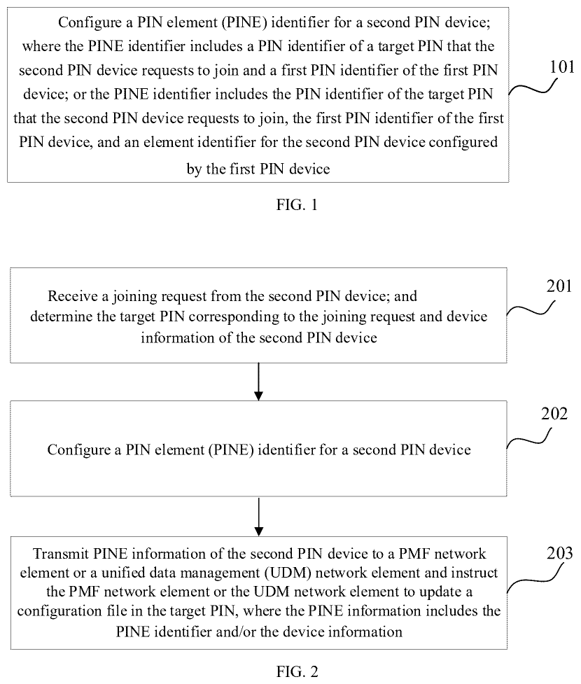

As shown in FIG. 1, an embodiment of the present disclosure provides an identifier configuration method. The method may be applied to a first Personal Internet of Things (IoT) Network (PIN) device. The method may include the following step 101.

At step 101, a PIN Element (PINE) identifier is configured for a second PIN device.

The PINE identifier includes a PIN identifier of a target PIN that the second PIN device requests to join and a first PIN identifier of the first PIN device.

Alternatively, the PINE identifier includes the PIN identifier of the target PIN that the second PIN device requests to join, the first PIN identifier of the first PIN device, and an element identifier configured by the first PIN device for the second PIN device.

The first PIN device may be a PINE with gateway capability or a PINE with management capability; the PINE with gateway capability is, for example, a PINE gateway capability (PEGC) device and the PINE with management capability is, for example, PINE management capability (PEMC) device or a PIN Management Function (PMF) device.

The second PIN device is a PINE, for example, a wearable device, a smart household device or a smart office device. The PIN device can access a network via a PINE with gateway function and directly connect via a PIN with a PINE outside scope for communication.

Under normal circumstances, one PIN includes at least one PINE with gateway capability and at least one PINE with management capability.

When the first PIN device configures the PINE identifier for the second PIN device, for example, in the scenario where the second PIN device requests to join a target PIN or the second PIN device requests to access a PEGC device, the PINE identifier includes the two configuration manners:

Configuration manner 1: a PIN identifier of the target PIN that the second PIN device requests to join, and a first PIN identifier of the first PIN device; or,

Configuration manner 2: the PINE identifier includes the PIN identifier of the target PIN that the second PIN device requests to join, the first PIN identifier of the first PIN device, and an element identifier configured by the first PIN device for the second PIN device.

In the configuration manner 1, the PINE identifier includes the PIN identifier of the target PIN and the first PIN identifier, where the PIN identifier is used to identify a PIN to which the PINE belongs, and the first PIN identifier is used to identify the PIN device; the element identifier is used to identify the element, for example, identify the PINEs at the time of PIN communication by 5G core network or by PEGC device or directly; in this manner, the element identifier is not included, for example, for a PINE with gateway capability or a PINE with management capability, the first PIN device may configure a PINE identifier not including the element identifier of the PINE.

In the configuration manner 2, the PINE identifier includes the PIN identifier of the target PIN and the first PIN identifier, and for a PINE without gateway capability or management capability, the first PIN device configures a PINE identifier including the element identifier of the PINE to facilitate mutual identification at the time of PIN communication between PINEs by 5G core network or by PEGC device or directly.

Capability information of the second PIN device may be reported by the present device. For example, when requesting to join a PIN, the second PIN device may report its capability information.

In an embodiment of the present disclosure, the PINE identifier is configured for the second PIN device by the first PIN device, and the PINE identifier includes: the PIN identifier of the target PIN that the second PIN device requests to join and the first PIN identifier of the first PIN device; or the PINE identifier includes the PIN identifier of the target PIN that the second PIN device requests to join, the first PIN identifier of the first PIN device, and the element identifier configured by the first PIN device for the second PIN device. In an embodiment of the present disclosure, a manner of configuring an identifier for a PIN element is provided to realize identification and management on the PIN and perfect PIN communication process.

In an embodiment of the present disclosure, the first PIN device includes at least one of a target PINE Gateway Capability (PEGC) device, a target PINE Management Capability (PEMC) device and a target PIN Management Function (PMF) network element; the target PEGC device is a PEGC device with gateway capability in the target PIN, and the target PIN is, for example, a PIN that the second PIN device requests to join; the target PEMC device is a PEMC device with management capability in the target PIN and the target PMF network element is a device with management function in the target PIN.

In one embodiment, when the first PIN device includes the target PEGC device or target PEMC device, before the PINE identifier is configured for the second PIN device, the method includes:

receiving a joining request from the second PIN device; and determining the target PIN corresponding to the joining request and device information of the second PIN device; where the target PEGC device or target PEMC device are PINEs in the target PIN; when the first PIN device includes the target PEGC device or target PEMC device, the target PEGC device or target PEMC device receives the joining request from the second PIN device, where the joining request carries the device information of the second PIN device, which may, for example, include device ID or Media Access Control (MAC) address, capability, service, and valid time and the like.

As shown in FIG. 2, an embodiment of the present disclosure provides an identifier configuration method. The method may be applied to a first Personal Internet of Things (IoT) Network (PIN) device. The first PIN device includes a target PEGC device or target PEMC device. The method may include the following steps 201 to 203.

At step 201, a joining request is received from a second PIN device; and a target PIN corresponding to the joining request and device information of the second PIN device are determined.

At step 202, a PIN Element (PINE) identifier is configured for the second PIN device; where the PINE identifier includes a PIN identifier of the target PIN that the second PIN device requests to join and a first PIN identifier of the first PIN device; or the PINE identifier includes the PIN identifier of the target PIN that the second PIN device requests to join, the first PIN identifier of the first PIN device, and an element identifier configured by the first PIN device for the second PIN device.

At step 203, PINE information of the second PIN device is transmitted to a PMF network element or a UDM network element and the PMF network element or the UDM network element is instructed to update a configuration file in the target PIN; the PINE information includes the PINE identifier and/or the device information.

When receiving the joining request from the second PIN device, the target PEGC device or target PEMC device transmit the PINE identifier and the device information to the PMF network element or UDM network element such that the PMF network element or UDM network element can update the configuration file in the target PIN to add the PINE identifier and the device information to the configuration file and perform authorization for the second PIN device to join the target PIN.

In one embodiment, after the PINE information of the second PIN device is transmitted to the PMF network element or UDM network element, the method further includes:

After the PMF network element or the UDM network element performs authorization for the first PIN device, PIN information of the target PIN and/or the PINE information are transmitted to the second PIN device. After the PMF network element or the UDM network element performs authorization for the second PIN device, the first PIN device feeds the PIN information of the target PIN and/or the PINE information back to the second PIN device.

The first PIN device may also feed an authorization result back to the second PIN device, where the authorization result, for example, is authorization for the second PIN device to join the target PIN or not.

As a first example, as shown in FIG. 3, it shows a process of an identifier configuration method provided by an embodiment of the present disclosure. The second PIN device is a PINE in FIG. 3 and the first PIN device is a PEGC device/PEMC device in FIG. 3. The PMF/UDM in FIG. 3 represents PMF network element or UDM network element. The method mainly includes the following steps 1 to 6.

At step 1, the PINE transmits a joining request to the PEGC device/PEMC device; the joining request may carry device information of the second PIN device and the device information may, for example, include device ID, or MAC address, capability, service and valid time and the like.

At step 2, the PEGC device/PEMC device configures a PINE identifier for the PINE.

At step 3, the PEGC device/PEMC device transmits PINE information to the PMF/UDM, where the PINE information includes the PINE identifier and the device information.

At step 4, the PMF/UDM performs authorization for the PINE and updates a configuration file.

At step 5, the PMF/UDM feeds an authorization result back to the PEGC device/PEMC device.

At step 6, the PEGC device/PEMC device feeds PIN information and/or the PINE information back to the PINE to perform the PINE identifier configuration flow.

In one embodiment, when the first PIN device includes a target PMF network element, before the PINE identifier is configured for the second PIN device, the method includes:

receiving the joining request forwarded by the PEGC device or PEMC device from the second PIN device and determining the target PIN corresponding to the joining request and the device information of the second PIN device.

The PEGC device or PEMC device receives the joining request from the second PIN device and forwards the joining request to the PMF network element, and the PMF network element determines whether to accept the joining request.

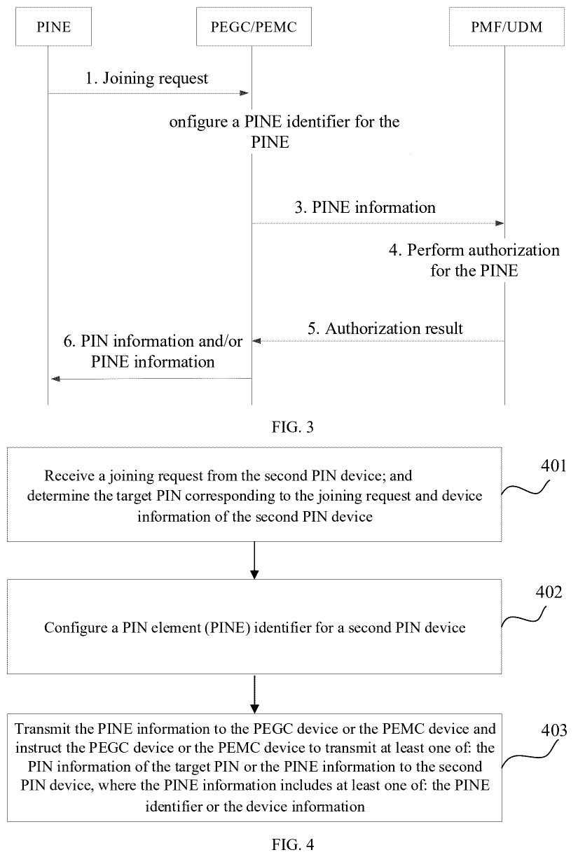

As shown in FIG. 4, an embodiment of the present disclosure provides an identifier configuration method. The method may be applied to a Personal Internet of Things (IoT) Network (PIN) device. The first PIN device includes a target PMF network element. The method includes the following steps 401 to 403.

At step 401, a joining request forwarded by a PEGC device or PEMC device from a second PIN device is received, and a target PIN corresponding to the joining request and device information of the second PIN device are determined.

At step 402, a PIN Element (PINE) identifier is configured for the second PIN device.

The PINE identifier includes a PIN identifier of the target PIN that the second PIN device requests to join and a first PIN identifier of the first PIN device; or, the PINE identifier includes the PIN identifier of the target PIN that the second PIN device requests to join, the first PIN identifier of the first PIN device, and an element identifier configured by the first PIN device for the second PIN device.

At step 403, PINE information is transmitted to the PEGC device or PEMC device and the PEGC device or the PEMC device is instructed to transmit PIN information of the target PIN and/or the PINE information to the second PIN device; where the PINE information includes the PINE identifier and/or the device information.

When accepting the joining request of the second PIN device, the target PMF network element updates a configuration file of the target PIN and adds the PINE identifier and the device information to the configuration file and performs authorization on the second PIN device to join the target PIN; and transmits the PINE identifier and the device information to a target PEGC device or target PEMC device which transmits the PIN information of the target PIN and/or the PINE information to the second PIN device.

As a second example, as shown in FIG. 5, it shows a process of an identifier configuration method provided by an embodiment of the present disclosure. The second PIN device is a PINE in FIG. 5, and the first PIN device is a PMF network element in FIG. 5. The PEGC device/PEMC device in FIG. 5 represents a target PEGC device or target PEMC device. The method mainly includes the following steps 1 to 5.

At step 1, The PINE transmits a joining request to the PEGC device/PEMC device; the joining request may carry device information of the second PIN device and the device information, for example, includes device ID or MAC address, capability, service, and valid time and the like.

At step 2, the PEGC device/PEMC device forwards the joining request to the PMF network element.

At step 3, the PMF network element configures a PINE identifier for the PINE and performs authorization for the PINE.

At step 4, the PMF feeds PINE information and an authorization result back to the PEGC device/PEMC device.

At step 5, the PEGC device/PEMC device feeds PIN information and/or the PINE information back to the PINE to perform the PINE identifier configuration flow.

In one embodiment, the device information includes at least one of capability information, device identifier, MAC address, service information and valid time of the second PIN device.

The capability information is, for example, hardware capability information of the device, and the hardware capability information is, for example, whether there is a capability to serve as a PEGC device and/or a PEMC device.

The device identifier is, for example, International Mobile Equipment Identity (IMEI), Mobile Equipment Identifier (MEID) or another device identifier of device parameter type.

The service information includes, for example, a service provided by the PINE, such as printer service by a printer and electric lamp service provided by an electric lamp, and the like.

The valid time information indicates a valid time of the device serving as PINE, for example, N hours, where N is a positive integer.

In one embodiment, when the device information includes the capability information of the second PIN device:
if the capability information indicates the second PIN device has a capability to serve as a PEGC device and/or a PEMC device, the PINE identifier includes: the PIN identifier and the first PIN identifier of the first PIN device; for a PINE with gateway capability or management capability, the first PIN device may configure a PINE identifier which does not include the element identifier of the PINE;
if the capability information indicates the second PIN device does not have a capability to serve as a PEGC device and/or a PEMC device, the PINE identifier includes: the PIN identifier, the first PIN identifier of the first PIN device and the element identifier; for a PINE without gateway capability or management capability, the first PIN device may configure a PINE identifier which includes the element identifier of the PINE to facilitate mutual identification at the time of PIN communication between the PINEs by 5G core network or by PEGC device or directly.

In an embodiment of the present disclosure, the PINE identifier is configured for the second PIN device by the first PIN device, and the PINE identifier includes: the PIN identifier of the target PIN that the second PIN device requests to join and the first PIN identifier of the first PIN device; or the PINE identifier includes the PIN identifier of the target PIN that the second PIN device requests to join, the first PIN identifier of the first PIN device, and the element identifier configured by the first PIN device for the second PIN device.

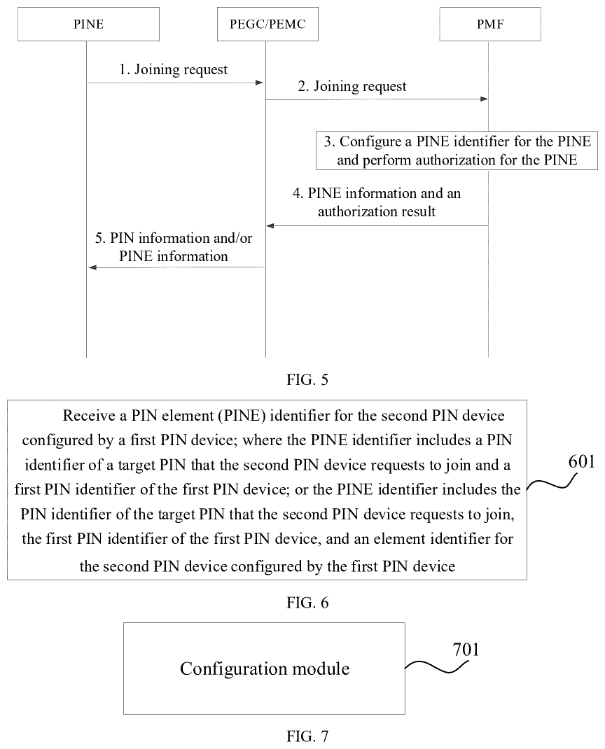

As shown in FIG. 6, an embodiment of the present disclosure provides an identifier configuration method. The method may be applied to an electronic device which may be a second Personal Internet of Things (IoT) Network (PIN) device. The method may include the following step 601.

At step 601, a PIN Element (PINE) identifier configured by a first PIN device for the second PIN device is received.

The PINE identifier includes: a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier configured by the first PIN device for the second PIN device.

The second PIN device is a PINE such as a wearable device, a smart household device and a smart office device. The PIN device can access a network via a PINE with gateway function and directly connect via a PIN with a PINE outside scope for communication. The first PIN device may be a PINE with gateway capability or management capability. The PINE with gateway capability is, for example, a PEGC device, and the PINE with management capability is, for example, a PEMC device or PMF device.

Under normal circumstances, one PIN includes at least one PINE with gateway capability and at least one PINE with management capability.

When the second PIN device receives the PINE identifier configured by the first PIN device for the second PIN device, for example, in the scenario where the second PIN device requests to join the target PIN or the second PIN device requests to access the PEGC device, the PINE identifier includes the following two configuration manners.

Configuration manner 1: the PIN identifier of the target PIN that the second PIN device requests to join, and the first PIN identifier of the first PIN device; or,

Configuration manner 2: the PINE identifier includes the PIN identifier of the target PIN that the second PIN device requests to join, the first PIN identifier of the first PIN device, and the element identifier configured by the first PIN device for the second PIN device.

In the configuration manner 1, the PINE identifier includes the PIN identifier of the target PIN and the first PIN identifier, where the PIN identifier is used to identify a PIN to which the PINE belongs, and the first PIN identifier is used to identify the PIN device; the element identifier is used to identify the element, for example, identify the PINEs at the time of PIN communication by 5G core network or by PEGC device or directly; in this manner, the element identifier is not included, for example, for a PINE with gateway capability or a PINE with management capability, the first PIN device may configure a PINE identifier not including the element identifier of the PINE.

In the configuration manner 2, the PINE identifier includes the PIN identifier of the target PIN and the first PIN identifier, and for a PINE without gateway capability or management capability, the first PIN device configures a PINE identifier including the element identifier of the PINE to facilitate mutual identification at the time of PIN communication between PINEs by 5G core network or by PEGC device or directly.

Capability information of the second PIN device may be reported by the present device. For example, when requesting to join a PIN, the second PIN device may report its capability information.

In one embodiment, before the PINE identifier configured by the first PIN device for the second PIN device is received, the method includes:
transmitting a joining request to a PEGC device or PEMC device, where the joining request carries identifier information of the target PIN and device information of the second PIN device.

The PEGC device or PEMC device is a PINE in the target PIN, and when the first PIN device includes the PEGC device or PEMC device, the second PIN device transmits the joining request to the PEGC device or PEMC device; with reference to the step 1 in the first and second examples, the PEGC device or PEMC device may configure the PINE identifier for the first PIN device based on the joining request (referring to the first example); or forward the joining request to a PMF which performs configuration operation (referring to the second example).

The joining request may carry the device information of the second PIN device, and the device information, for example, includes device ID or MAC address, capability, service and valid time and the like.

In one embodiment, after the PINE identifier configured by the first PIN device for the second PIN device is received, the method includes:

receiving PIN information of the target PIN and/or PINE information from the PEGC device or PEMC device; where the PINE information includes the PINE identifier and/or the device information of the second PIN device. The PINE identifier may be configured by PEGC device or PEMC device or PMF network element, and the PEGC device or PEMC device transmits the PIN information and/or the PINE information to the second PIN device such that the second PIN device can perform communication in the target PIN based on the PIN information and/or PINE information.

In one embodiment, the second PIN device may also receive an authorization result from the first PIN device, and the authorization result, for example, is authorization for the second PIN device to join the target PIN or not.

In one or more embodiments of the present disclosure, the second PIN device receives a PIN element (PINE) identifier for the second PIN device configured by the first PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device. An embodiment of the present disclosure provides a manner of configuring an identifier for a PIN element to realize identification and management on the PIN element and perfect PIN communication process.

Referring to FIG. 7, based on the same principles as the method provided by the embodiments of the present disclosure, the embodiments of the present disclosure also provide an electronic device, the electronic device is a first PIN device, and the electronic device includes a configuration module 701.

The configuration module 701 is configured to configure a PIN element (PINE) identifier for a second PIN device.
where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

In an embodiment, the first PIN device includes at least one of: a target PINE gateway capability (PEGC) device, a target PINE management capability (PEMC) device, or a target PIN management function (PMF) network element.

In an embodiment, the electronic device includes a first receiving module.

When the first PIN device includes the target PEGC device or the target PEMC device, the first receiving module is configured to, before configuring the PINE identifier for the second PIN device: receive a joining request from the second PIN device; and determine the target PIN corresponding to the joining request and device information of the second PIN device.

In an embodiment, the electronic device includes a transmitting module.

The transmitting module is configured to, after configuring the PINE identifier for the second PIN device: transmit PINE information of the second PIN device to a PMF network element or a unified data management (UDM) network element and instruct the PMF network element or the UDM network element to update a configuration file in the target PIN, where the PINE information includes the PINE identifier and/or the device information.

In an embodiment, the electronic device further includes a second transmitting module.

The second transmitting module is configured to, after transmitting the PINE information of the second PIN device to the PMF network element or the UDM network element: transmit at least one of: PIN information of the target PIN or the PINE information to the second PIN device after the PMF network element or the UDM network element performs authorization for the first PIN device.

In an embodiment, the electronic device further includes a second transmitting module.

When the first PIN device includes a target PMF network element, the second transmitting module is configured to, before configuring the PINE identifier for the second PIN device: receive the joining request, from the second PIN device, forwarded by a PEGC device or a PEMC device; and determine the target PIN corresponding to the joining request and the device information of the second PIN device.

In an embodiment, the electronic device further includes a third transmitting module.

The third transmitting module is configured to: transmit the PINE information to the PEGC device or the PEMC device and instruct the PEGC device or the PEMC device to transmit at least one of: the PIN information of the target PIN or the PINE information to the second PIN device, where the PINE information includes at least one of: the PINE identifier or the device information.

In an embodiment, the device information includes at least one of: capability information, a device identifier, a media access control (MAC) address, service information or valid time information of the second PIN device.

In an embodiment, the device information includes the capability information of the second PIN device. In response to the capability information indicating that the second PIN device has a capability to serve as at least one of: a PEGC device or a PEMC device, the PINE identifier includes: the PIN identifier and the first PIN identifier of the first PIN device; in response to the capability information indicating that the second PIN device does not have a capability to serve as at least one of: a PEGC device or a PEMC device, the PINE identifier includes: the PIN identifier, the first PIN identifier of the first PIN device, and the element identifier.

In one or more embodiments of the present disclosure, a PINE identifier is configured for a second PIN device by the configuration module 701, and the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device and an element identifier configured by the first PIN device for the second PIN device.

The embodiments of the present disclosure provide an identifier configuration apparatus, applied to a first personal internet of things (IoT) network (PIN) device and including: an identifier configuration module.

The identifier configuration module is configured to configure a PIN element (PINE) identifier for a second PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

The apparatus also includes other modules of the electronic device in the embodiments, which are not described herein.

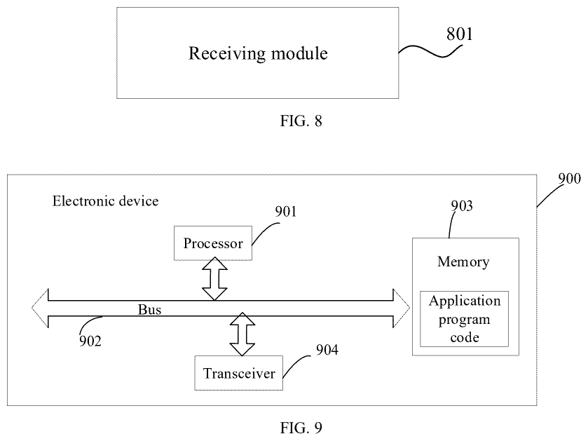

Referring to FIG. 8, based on the same principles as the method provided by the embodiments of the present disclosure, the embodiments of the present disclosure also provide an electronic device, the electronic device is a second PIN device, and the electronic device includes a receiving module 801.

The receiving module 801 is configured to receive a PIN element (PINE) identifier for the second PIN device configured by a first PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

In an embodiment, the electronic device includes a request transmitting module.

The request transmitting module is configured to transmit a joining request to a PINE gateway capability (PEGC) device or PINE management capability (PEMC) device, where the joining request carries identifier information of the target PIN and device information of the second PIN device.

In an embodiment, the electronic device includes an information receiving module.

The information receiving module is configured to receive at least one of: PIN information of the target PIN transmitted by the PEGC device or PEMC device, or PINE information, where the PINE information includes the PINE identifier and/or the device information of the second PIN device.

In one or more embodiments of the present disclosure, the receiving module 801 receives a PIN element (PINE) identifier for the second PIN device configured by the first PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

The embodiments of the present disclosure provide an identifier configuration apparatus, applied to a second personal internet of things (IoT) network (PIN) device and including: an identifier receiving module.

The identifier receiving module is configured to receive a PIN element (PINE) identifier for the second PIN device configured by a first PIN device; where the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device, and an element identifier for the second PIN device configured by the first PIN device.

The apparatus also includes other modules of the electronic device in the embodiments, which are not described herein.

The embodiments of the present disclosure also provide an electronic device, as shown in FIG. 9, the electronic device 900 may be a server including: a processor 901 and a memory 903. The processor 901 and the memory 903 are connected, e.g., via a bus 902. In an embodiment, the electronic device 900 may also include a transceiver 904. It will be noted that the transceiver 904 is not limited to one in number in practical applications, and the structure of the electronic device 900 does not constitute a limitation of the embodiments of the present disclosure.

The processor 901 may be a central processing unit (CPU), a general purpose processor, a digital signal processor (DSP), an application specific integrated circuit (ASIC), a field programmable gate array (FPGA) or other programmable logic device, a transistor logic device, a hardware component or any combination thereof. The processor 901 may implement or perform various illustrative logical blocks, modules, and circuits described in connection with the present disclosure. The processor 901 may also be a combination for realizing computing functions, for example, including a combination of one or more microprocessor, a combination of digital signal processor (DSP) and microprocessor, etc.

The bus 902 may include a pathway to transfer information between the foregoing components. The bus 902 may be a peripheral component interconnect (PCI) bus or an extended industry standard architecture (EISA) bus, and so on. The bus 902 may include an address bus, a data bus, a control bus, and so on. For ease of representation, only a thick line is shown in FIG. 9, but it does not mean that there is only one bus or one type of bus.

The memory 903 may be a read only memory (ROM) or other type of static storage device that can store static information and instructions, a random access memory (RAM) or other type of dynamic storage device that can store information and instructions. It can also be an electrically erasable programmable read only memory (EEPROM), a compact disc read only memory (CD-ROM), CD-ROM) or other optical storage (including a compact disc, a laser disc, an optical disc, a digital versatile disc, a Blu-ray disc, etc.), magnetic storage medium or other magnetic storage devices, or any other medium that can be used to carry or store desired program codes in the form of instructions or data structures and can be accessed by a computer, but is not limited thereto.

The memory 903 is configured to store the application program code for executing the scheme of the present disclosure and is controlled for execution by processor 901. The processor 901 is configured to execute the application program code stored in the memory 903 to implement the foregoing method embodiments.

The electronic device includes, but is not limited to, a mobile terminal such as a cell phone, a laptop computer, a digital broadcast receiver, a personal digital assistant (PDA), a portable android device (PAD), a portable multimedia player (PMP), an on-board terminal (such as an on-board navigation terminal), as well as a stationary terminal (such as a digital TV, a desktop computer), and the like. The electronic device shown in FIG. 9 is only an example, and will not limit to the functions and use scope of the embodiments of the present disclosure.

The server provided by the present disclosure may be an independent physical server, a server cluster or distributed system including a plurality of physical servers, and a cloud server providing basic cloud computing services such as cloud services, cloud databases, cloud computing, cloud functions, cloud storage, network services, cloud communications, middleware services, domain name services, security services, CDNs, and big data and artificial intelligence platforms. The terminal can be a smartphone, tablet, laptop, desktop computer, smart speaker, smartwatch, etc., but is not limited to these. The terminal and the server can be directly or indirectly connected through wired or wireless communication, and the present disclosure is not limited herein.

Embodiments of the present disclosure provide a computer-readable storage medium having computer programs stored thereon, which, when run on a computer, cause the computer to execute the corresponding contents of the foregoing method embodiments.

It will be understood that although the individual steps in the flowchart of the accompanying drawings are shown sequentially as indicated by arrows, the steps are not necessarily executed sequentially in the order indicated by the arrows. Unless expressly stated herein, there is no strict order limitation on the execution of these steps, which may be executed in some other order. At least a portion of the steps in the flowchart of the accompanying drawings may include a plurality of sub-steps or a plurality of phases, the sub-steps or phases are not necessarily executed to completion at the same moment but may be executed at different moments, and the order of execution thereof is not necessarily sequential, but may be executed in turn or in alternation with at least a portion of the other steps or sub-steps or phases of the other steps.

It will be noted that the computer-readable medium shown in the present disclosure may be a computer readable signal medium or a computer readable storage medium or any combination thereof. The computer-readable storage medium may be, but is not limited to, an electrical, magnetic, optical, electromagnetic, infrared, or semiconductor system, apparatus, or component, or any combination thereof. More specific examples of the computer readable storage medium may include, but are not limited to: an electrical connection having one or more wires, a portable computer disk, a hard disk, a random access memory (RAM), a read-only memory (ROM), an erasable programmable read only memory (EPROM or a flash memory), an optical fiber, a portable compact disk read-only memory (CD-ROM), an optical storage device, a magnetic storage device, or any suitable combination thereof. In the present disclosure, the computer readable storage medium may be any tangible medium including or storing a program, and the program may be used by or in combination with an instruction execution system, apparatus, or device. In the present disclosure, the computer readable signal medium may be a data signal included in a baseband or propagated as a part of a carrier, in which computer readable program code is carried. This propagated data signal can take many forms, including but not limited to electromagnetic signals, optical signals, or any suitable combination thereof. The computer-readable signal medium may also be any computer-readable medium other than a computer-readable storage medium, and the computer-readable medium may send, propagate, or transmit a program for use by or in combination with an instruction execution system, an apparatus, or a component. The program code contained on the computer-readable medium may be transmitted using any appropriate medium, including but not limited to: wireless, wire, optical cable, RF, etc., or any suitable combination of the foregoing.

The computer-readable medium may be included in the electronic device; or the computer-readable medium may exist independently without being assembled into the electronic device.

The computer-readable medium carries one or more programs, which, when executed by the electronic device, cause the electronic device to perform the method in the embodiments.

According to an aspect of the present disclosure, there is provided a computer program product or computer program including computer instructions which are stored in a computer-readable storage medium. The processor of the computer device reads the computer instructions from a computer-readable storage medium, executes the computer instructions, and causes the computer device to perform the methods provided in the various optional implementations.

A program code for performing the operation of the present disclosure may be written by using any combination of one or more programming languages. The programming language includes an object-oriented programming language such as Java, C++, and a conventional procedural programming language such as a “C” Language or a similar programming language. The program code may be fully executed on a computer of a user or partially executed on a computer of a user, or may be executed as an independent software package, or may be partially executed on a computer of a user and partially executed on a remote computer, or may be fully executed on a remote computer or a server. In case of the remote computer, the remote computer may be connected to the computing device of a user by using any network including a local area network (LAN) or a wide area network (WAN), or may be connected to an external computer (for example, connected to the external computer through the Internet by using an Internet service provider).

Flowcharts and block diagrams in the drawings illustrate architectures, functions, and operations that may be implemented by using the system, the method, and the computer program product according to the various embodiments of the present disclosure. In this regard, each block in the flowchart or the block diagram may represent a module, a program segment, or a part of code. The module, the program segment, or the part of the code includes one or more executable instructions for implementing a specified logical function. It will also be noted that, in some alternative implementations, the functions noted in the blocks may occur in an order different from that noted in the drawings. For example, two blocks shown in succession can actually be executed in parallel, and sometimes they can also be executed in a reverse order, depending on the functions involved. It should also be noted that each block in the block diagrams and/or flowcharts, and combinations of blocks in the block diagrams and/or flowcharts, can be implemented with dedicated hardware-based systems that perform specified functions or operations, or a combination of dedicated hardware and computer instructions.

The modules described in the embodiments of the present disclosure may be implemented in software or hardware. A name of a module does not constitute a limitation on the module itself in some cases. For example, a module A can also be described as a “module A used to perform an operation B”.

In one or more embodiments of the present disclosure, a PINE identifier is configured for a second PIN device by a first PIN device, and the PINE identifier includes a PIN identifier of a target PIN that the second PIN device requests to join and a first PIN identifier of the first PIN device; or the PINE identifier includes the PIN identifier of the target PIN that the second PIN device requests to join, the first PIN identifier of the first PIN device and an element identifier configured by the first PIN device for the second PIN device. An embodiment of the present disclosure provides a manner of configuring an identifier for a PIN element to realize identification and management on the PIN element and perfect PIN communication process.

The above description is only some embodiments of the present disclosure and an explanation of the applied technical principles. Those skilled in the art should understand that the scope of the invention involved in the present disclosure is not limited to a technical solution formed by a specific combination of the above technical features, but should also cover other technical solutions formed by any combination of the above technical features or their equivalents without departing from the inventive concept of the present disclosure. For example, technical solutions formed by replacing the above features with the technical features having similar functions disclosed in (but not limited to) the present disclosure.

1. A method for identifier configuration, performed by a first (PIN) device in a personal internet of things (loT)-network, the method and comprising:
configuring a PIN element (PINE) identifier for a second PIN device;
wherein the PINE identifier comprises a PIN identifier of a target PIN that the second PIN device requests to join and a first PIN identifier of the first PIN device; or the PINE identifier comprises the PIN identifier of the target PIN that the second PIN device requests to join, the first PIN identifier of the first PIN device, and an element identifier for the second PIN device configured by the first PIN device.

2. The method of claim 1, wherein the first PIN device comprises at least one of: a target PINE gateway capability (PEGC) device, a target PINE management capability (PEMC) device, or a target PIN management function (PMF) network element.

3. The method of claim 2, wherein when the first PIN device comprises the target PEGC device or the target PEMC device, the method further comprises, before configuring the PINE identifier for the second PIN device:
receiving a joining request from the second PIN device; and
determining the target PIN corresponding to the joining request and device information of the second PIN device.

4. The method of claim 3, wherein the method further comprises, after configuring the PINE identifier for the second PIN device:
transmitting PINE information of the second PIN device to a PMF network element or a unified data management (UDM) network element and instructing the PMF network element or the UDM network element to update a configuration file in the target PIN, wherein the PINE information comprises at least one of: the PINE identifier or the device information.

5. The method of claim 4, wherein the method further comprises, after transmitting the PINE information of the second PIN device to the PMF network element or the UDM network element:
transmitting at least one of: PIN information of the target PIN or the PINE information to the second PIN device after the PMF network element or the UDM network element performs authorization for the first PIN device.

6. The method of claim 2, wherein when the first PIN device comprises a target PMF network element, the method further comprises, before configuring the PINE identifier for the second PIN device:
receiving the joining request, from the second PIN device, forwarded by a PEGC device or a PEMC device; and
determining the target PIN corresponding to the joining request and the device information of the second PIN device.

7. The method of claim 6, wherein the method further comprises, after configuring the PINE identifier for the second PIN device:
transmitting the-PINE information to the PEGC device or the PEMC device and instructing the PEGC device or the PEMC device to transmit at least one of: the PIN information of the target PIN or the PINE information to the second PIN device, wherein the PINE information comprises at least one of: the PINE identifier or the device information.

8. The method of claim 3, wherein the device information comprises at least one of: capability information, a device identifier, a media access control (MAC) address, service information or valid time information of the second PIN device.

9. The method of claim 8, wherein the device information comprises the capability information of the second PIN device,
in response to the capability information indicating that the second PIN device has a capability to serve as at least one of: a PEGC device or a PEMC device, the PINE identifier comprises: the PIN identifier and the first PIN identifier of the first PIN device;
in response to the capability information indicating that the second PIN device does not have a capability to serve as at least one of: the PEGC device or a the PEMC device, the PINE identifier comprises: the PIN identifier, the first PIN identifier of the first PIN device, and the element identifier.

10. An method for identifier configuration, performed by a second (PIN) device in personal internet of things (IoT) network, the method and comprising:
receiving a PIN element (PINE) identifier for the second PIN device configured by a first PIN device;
wherein the PINE identifier comprises a PIN identifier of a target PIN that the second PIN device requests to join and a first PIN identifier of the first PIN device; or the PINE identifier comprises the PIN identifier of the target PIN that the second PIN device requests to join, the first PIN identifier of the first PIN device, and an element identifier for the second PIN device configured by the first PIN device.

11. The method of claim 10, wherein the method further comprises, before receiving the PINE identifier for the second PIN device configured by the first PIN device:
transmitting a joining request to a PINE gateway capability (PEGC) device or PINE management capability (PEMC) device, wherein the joining request carries identifier information of the target PIN and device information of the second PIN device.

12. The method of claim 11, wherein the method further comprises, after receiving the PINE identifier for the second PIN device configured by the first PIN device:
receiving at least one of: PIN information of the target PIN transmitted by the PEGC device or PEMC device, or PINE information, wherein the PINE information comprises at least one of: the PINE identifier or the device information of the second PIN device.

13.-16. (canceled)

17. A first (PIN) device for use in an internet of things (IoT) network, the first PIN device-device comprising:
a processor; and
a memory storing computer programs executable by the processor, wherein the computer programs; when executed by the processor, cause the first PIN device to:
configure a PIN element (PINE) identifier for a second PIN device;
wherein the PINE identifier comprises a PIN identifier of a target PIN that the second PIN device requests to join and a first PIN identifier of the first PIN device; or the PINE identifier comprises the PIN identifier of the target PIN that the second PIN device requests to join, the first PIN identifier of the first PIN device, and an element identifier for the second PIN device configured by the first PIN device.

18. A non-transitory_computer-readable storage medium, storing computer programs thereon, wherein the computer programs, when executed by a processor of first PIN device, cause the first PIN device to perform the method of claim 1.

19. A electronic device comprising:
a processor; and a memory storing computer programs executable by the processor, wherein the computer programs; when executed by the processor, cause the electronic device to act as the second PIN device and perform the identifier configuration method of claim 10.

20. A non-transitory computer-readable storage medium, storing computer programs thereon, wherein the computer programs, when executed by a processor of the second PIN device, cause the second PIN device to perform the method of claim 10.

21. The first PIN device of claim 17, wherein the computer programs further cause the first PIN device to provide at least one of:
a target PINE gateway capability (PEGC) device,
a target PINE management capability (PEMC) device, or
a target PIN management function (PMF) network element.

22. The first PIN device of claim 21, wherein when the first PIN device provides the target PEGC device or the target PEMC device, the computer programs further cause the first PIN device to:
before configuring the PINE identifier for the second PIN device:
receive a joining request from the second PIN device; and
determine the target PIN corresponding to the joining request and device information of the second PIN device.

23. The first PIN device of claim 22, wherein the computer programs further cause the first PIN device to:
after configuring the PINE identifier for the second PIN device:
transmit PINE information of the second PIN device to a PMF network element or a unified data management (UDM) network element to instruct the PMF network element or the UDM network element to update a configuration file in the target PIN, wherein the PINE information comprises at least one of: the PINE identifier or the device information.

24. The first PIN device of claim 23, wherein the computer programs further cause the first PIN device to:
after transmitting the PINE information of the second PIN device to the PMF network element or the UDM network element:
transmit at least one of: PIN information of the target PIN or the PINE information to the second PIN device after the PMF network element or the UDM network element completes authorization for the first PIN device.
